(19) United States
(12) Patent Application Publication
(10) Pub. No.: US 2007/0184906 A1
(43) Pub. Date: Aug. 9, 2007

(54) Method of controlling interactions between objects

(76) Inventors: Michael Michael, London (GB); Miles Visman, London (GB)

Correspondence Address: STETINA BRUNDA GARRED & BRUCKER, 75 ENTERPRISE, SUITE 250, ALISO VIEJO, CA, 92656, US

(21) Appl. No.: 10/569,579

(22) PCT Filed: Aug. 25, 2005
(86) PCT No.: PCT/GB05/03307

§ 371 Date: Oct. 13, 2006

(30) Foreign Application Priority Data
Aug. 26, 2004 (GB) 0419039.3

(51) Int. Cl. A63F 13/00

(52) U.S. Cl. 463/43

(57) ABSTRACT

The invention relates to a method for controlling interactions between at least two objects. On pressing an activation button on a user device a user can set up an expanding boundary around one of the objects. The boundary expands up to a maximum distance. If a second object comes into contact with the boundary then the direction of movement of the second object may be altered. The speed of movement of the second object may also be altered. Alternatively, the shape of the second object may be altered on the second object coming into contact with the boundary.

This invention relates to a method for controlling the interaction between a first and second object displayed using a user interface. The invention is particularly, though not exclusively, applicable to use within computer games.

In the computer modelling industry often graphical images displayed on an interface interact with each other in some way. This interaction may be the direct or indirect result of user commands which have been inputted into the system.

The game “Missile Command” illustrates one way in which objects can interact with each other. In this game a user could “activate” an explosion at a certain point through the pressing of a designated button or key. Once the explosion was activated an expanding area around the point could be seen. This area expanded to a predefined maximum area and anything caught within the area covered by the explosion was “destroyed”.

A user may, however, wish to have subtler interactions between images not requiring the “destruction” of one or more images on the interface. These subtler interactions require a different interpretation of the way two objects interact with each other which is not needed for the interactions in “Missile Command”.

According to a first aspect of the invention there is provided a method for controlling the interaction between a first and second object displayed using a user interface comprising the steps of generating a boundary around the first object, the boundary expanding up to a maximum distance from the first object and altering the direction of movement of the second object to a second direction of movement when it comes into contact with the boundary. In this way a first object can be made to interact with a second object without any direct interaction between the objects.

Preferably, the direction and/or speed of movement of the second object is altered when the second object comes into contact with the boundary.

Preferably, the amount that the speed of movement of the second object is altered by is varied according to the distance of the boundary from the first object. In this way the closer the second object is to the epicentre of any interactive force from the first object the greater the force on the second object.

Preferably, the direction of movement of the second object is altered according to vector forces applied at the point where the boundary and second object meet. This makes the interactions between the objects more realistic.

According to a second aspect of the invention there is provided apparatus for controlling the interaction between a first and second object comprising a user interface for displaying the first and second objects and a processor for generating a boundary around the first object, the boundary expanding up to a maximum distance from the first object and altering the direction of movement of the second object to a second direction of movement when it comes into contact with the boundary.

According to a further aspect of the invention there is provided a computer readable medium carrying a computer program which when executed on a processor carries out the steps of generating a boundary around the first object, the boundary expanding up to a maximum distance from the first object and altering the direction of movement of the second object to a second direction of movement when it comes into contact with the boundary.

Embodiments of the invention will now be described, by way of example, and with reference to the drawings in which:

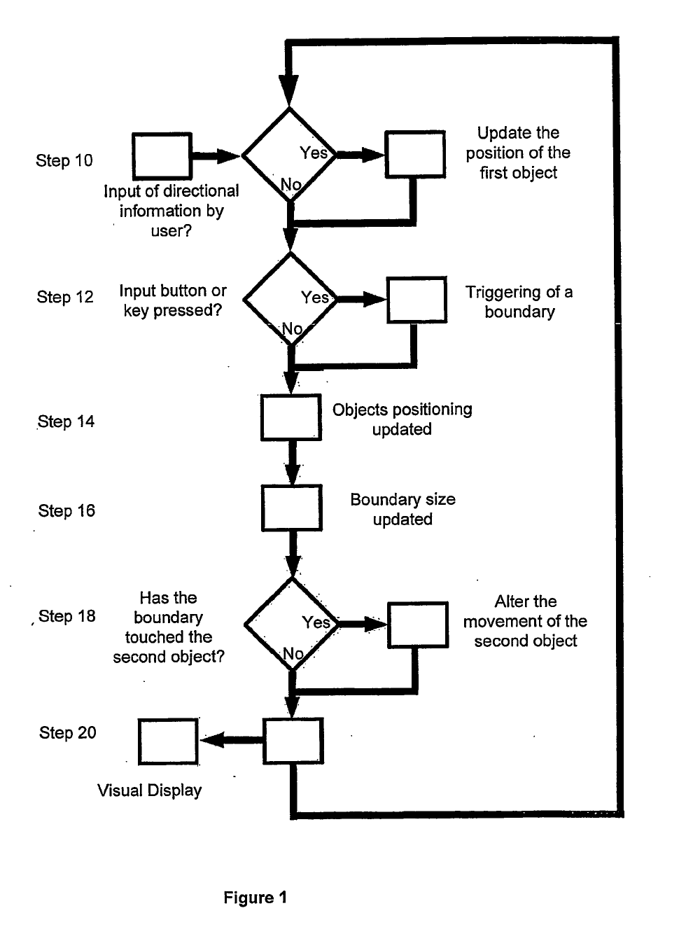

FIG. 1 illustrates a flow diagram of a method of controlling interaction between graphical objects;

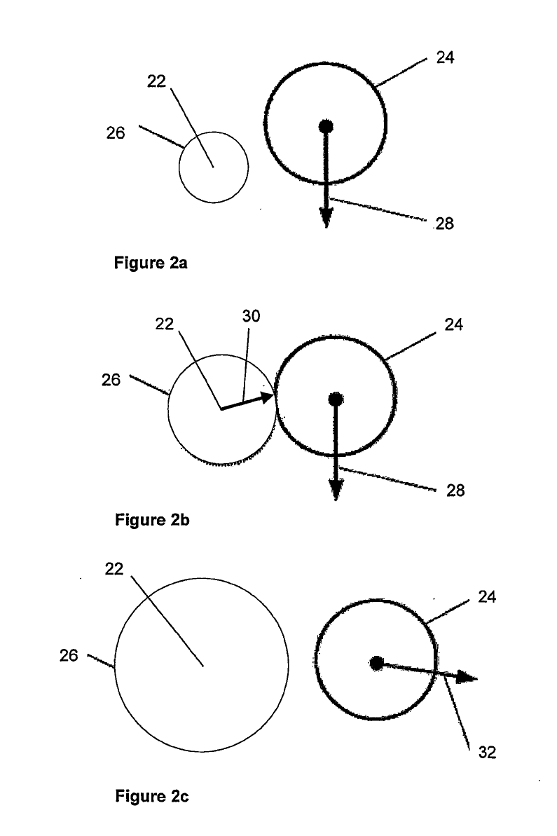

FIG. 2a illustrates an example graphical interface before the graphical object and boundary interact;

FIG. 2b illustrates an example graphical interface where a graphical object and boundary are interacting; and

FIG. 2c illustrates an example graphical interface after the graphical object and boundary have interacted.

According to the present invention there is provided a user interface and user device. The user interface preferably displays graphic objects on a display. The graphic objects may be, for example, balls that interact in the manner described below. Preferably the interface displays a first and second object on the display.

As illustrated in FIG. 1 the user may use the user device to alter the placement of the first object on the interface as shown in step 10. The user device is preferably designed to allow the user to input directional information into the system to control the placement of one, or more, objects on the screen. This may be done by using an analogue or digital device which may be, for example, a mouse, keyboard or joystick. Alternatively, the user device may comprise a microphone, a voice analyser and processor to allow the user to input directional information into the system in the form of voice commands.

On pressing an input button associated with the user device, as in Step 12, the user triggers a boundary to be created around the first object. Preferably the boundary increases from the first object to encompass an area around the first object. The size of area which the boundary encompasses may be determined by the length of time the button is depressed. Alternatively the area encompassed by the boundary may be predetermined and be the same for every depression of the button regardless of its length.

In steps 14 and 16 the user interface, shown on a display is shown to be repeatedly updated with respect to the position of objects upon the screen and boundaries on the screen respectively.

If the expanding boundary comes into contact with another graphical object on the screen then they may be arranged to interact with each other as shown in step 18. For example, the second object may change shape by becoming smaller or larger. Alternatively, on coming into contact with the boundary the graphical object may alter any movement that it is currently undergoing, for example the second object may change direction or speed. This change is shown on the visual display in Step 20.

Preferably the interaction is calculated according to vector forces as illustrated in FIGS. 2a, b and c. FIG. 2a illustrates an example graphical interface having a first object 22 and a second object 24 displayed upon it. The button on the user interface has just been activated causing a boundary 26 to begin expanding from the first object. The second object 24 can be seen to be travelling along vector 28.

In FIG. 2b the boundary 26 has expanded and is now touching the second object 24. This interaction will cause a vector force in direction 30 to be “exerted” on the object 24. The size of the force may be a fixed predetermined force, alternatively the size of the force may vary according to the area covered by the boundary 26.

When the boundary 26 touches the second object 24 the vector forces of the object 24 and that imparted by the boundary 26 will be added in order to calculate a new direction 32 and speed of movement for the object 24 as illustrated in FIG. 2c.

The new direction 32 and speed of the object 24 are not necessarily calculated using the above method. For example, on touching the boundary 26 the object 24 may be arranged such that the object 24 always moves away from the boundary in a predetermined direction.

Preferably once the boundary has expanded to its maximum distance from the first object the display of the first object on the interface is reset so that no boundary exists. This allows new interactions to be set up continuously using the same user input device.

It should be noted that the boundary around the first object may interact with more than one object at any one time and also that more than one boundary may be created around different objects at the same time. This can be done by selecting two or more objects either sequentially or as a combination.

Additionally, the first object may be a cursor control point which does not interact with any other objects displayed on the screen but allows the user to see where the focal point of the boundary is.

This interaction between two objects may also be carried out in a 3-dimensional user interface by using extra buttons to control movements in the z-axis.

1. A method for controlling the interaction between a boundary and a second object displayed using a user interface comprising the steps of:
(a) generating a boundary around a first object, the boundary expanding up to a maximum distance from the first object; and
(b) altering the direction of movement of the second object to a second direction of movement when it comes into contact with the boundary.

2. A method for controlling the interaction between a boundary and second object as claimed in claim 1 wherein the direction of movement of the second object is altered when the second object comes into contact with the boundary.

3. A method for controlling the interaction between a boundary and second object as claimed in claim 1 or claim 2 wherein the speed of movement of the second object is altered according to where on the boundary the second object touches.

4. A method for controlling the interaction between a boundary and second object as claimed in claim 2 or claim 3 wherein the amount that the speed of movement of the second object is altered by is varied according to the distance of the boundary from the first object.

5. A method for controlling the interaction between a boundary and second object as claimed in claim 3 or claim 4 wherein the direction of movement of the second object is altered according to vector forces applied at the point where the boundary and second object meet.

6. A method for controlling the interaction between a boundary and second object as claimed in claim 1 or claim 2 wherein the shape of the second object is altered when the second object comes into contact with the boundary.

7. A method for controlling the interaction between a boundary and second object as claimed in any preceding claim wherein the position of the first object is varied using a user input device.

8. A method for controlling the interaction between a boundary and second object as claimed in any preceding claim wherein the maximum distance of the boundary from the first object is varied using a user input device.

9. A method for controlling the interaction between a boundary and second object as claimed in any preceding claim wherein the user input device is a mouse, keyboard, or joystick.

10. A method for controlling the interaction between a boundary and second object as claimed in any of claims 1 to 8 wherein the user input device is responsive to voice commands.

11. Apparatus for controlling the interaction between a boundary and second object comprising a processor for generating a boundary around a first object, the boundary expanding up to a maximum distance from the first object and altering the direction of movement of the second object to a second direction of movement when it comes into contact with the boundary.

12. Apparatus for controlling the interaction between a boundary and second object as claimed in claim 9 further comprising an output for displaying the first and second objects.

13. Apparatus for controlling the interaction between a boundary and second object as claimed in claim 9 further comprising a user input device for controlling the position of the first object.

14. Apparatus for controlling the interaction between a boundary and second object as claimed in claim 11 wherein the user input device also determines the maximum distance of the boundary from the first object.

15. A computer readable medium carrying a computer program which when executed on a processor carries out the steps of:
(a) generating a boundary around a first object, the boundary expanding up to a maximum distance from the first object; and
(b) altering the direction of movement of a second object to a second direction of movement when it comes into contact with the boundary.

16. A client couplable to server arranged to:
(a) generate a boundary around a first object, the boundary expanding up to a maximum distance from the first object; and
(b) alter the direction of movement of a second object to a second direction of movement when it comes into contact with the boundary.

17. A computer program stored on a server for download which when executed server causes a processor to carry out the steps of:
(a) generating a boundary around a first object, the boundary expanding up to a maximum distance from the first object; and
(b) altering the direction of movement of a second object to a second direction of movement when it comes into contact with the boundary.
